(19) United States
(12) Patent Application Publication
(10) Pub. No.: US 2023/0351146 A1
(43) Pub. Date: Nov. 2, 2023

(54) DEVICE AND COMPUTER-IMPLEMENTED METHOD FOR A NEURAL ARCHITECTURE SEARCH

(71) Applicant: Robert Bosch GmbH, Stuttgart (DE)

(72) Inventors: Armin Runge, Pittsburgh, PA (US); Dayo Oshinubi, Rutesheim (DE); Falk Rehm, Renningen (DE); Michael Meixner, Reutlingen (DE); Michael Klaiber, Stuttgart (DE)

(21) Appl. No.: 18/002,305

(22) PCT Filed: Sep. 20, 2021
(86) PCT No.: PCT/EP2021/075768

§ 371 Date: Dec. 19, 2022

(30) Foreign Application Priority Data
Sep. 30, 2020 (DE) 10 2020 212 328.4

(51) Int. Cl. G06N 3/04

(52) U.S. Cl. CPC G06N 3/04

(57) ABSTRACT

A device and a computer-implemented method for a neural architecture search. A first set of values is provided for parameters that define at least one part of an architecture for an artificial neural network, wherein the part of the architecture encompasses a plurality of layers of the artificial neural network and/or a plurality of operations of the artificial neural network, wherein a first value of a function is determined for the first set of values for the parameters, said first value characterizing a property of a target system when the target system executes a task for the part of the artificial neural network that is defined by the first set of values for the parameters.

### FIELD

The present invention relates to a device and to a computer-implemented method for a neural architecture search.

### BACKGROUND INFORMATION

In deep neural networks, a search space for an architecture of the artificial neural network is already of a considerable size. Any neural architecture search that is particularly suited to a predetermined purpose is already highly complex. The architecture of the artificial neural network can be established in an automated manner on the basis of a cost function using the neural architecture search (NAS). The architecture search represents a multitarget optimization problem based on the cost function; targets such as a number of parameters or of operations in the artificial neural network are factored into the cost function in addition to, for example, the accuracy of the algorithms.

If certain parts of the artificial neural network are intended to be implemented in a target system, this additionally increases the effort required for the architecture search. On one hand, it is possible to select various parts of the artificial neural network which are either represented by the target system or not. On the other, target systems having different properties may be used in order to implement the same part of the artificial neural network.

### SUMMARY

The present invention provides a hardware-conscious cost function for an efficient and scalable automated architecture search. An automatic neural architecture search is thus possible even when using hardware-dependent optimization techniques for certain target systems.

Using a computer-implemented method and a device according to the present invention, a network architecture that is particularly suitable for carrying out a task for a calculation is determined for an artificial neural network.

According to the computer-implemented method of an example embodiment of the present invention for the neural architecture search, a first set of values is provided for parameters that define at least one part of an architecture for an artificial neural network, the part of the architecture encompassing a plurality of layers of the artificial neural network and/or a plurality of operations of the artificial neural network, a first value of a function being determined for the first set of values for the parameters, said first value characterizing a property of a target system when the target system executes a task for the part of the artificial neural network that is defined by the first set of values for the parameters. The function maps selected parameters of the artificial neural network to values that indicate costs for the execution of the task by the target system. The task includes calculating variables from the artificial neural network from a plurality of layers or a plurality of operations. The function constitutes a model of the target system for an architecture search. The parameters constitute dimensions that span a search space for the architecture search. As a result, comparative values for combinations of layers or operations, or for combinations of layers and operations in terms of the hardware costs, for example the latency, can be taken into account in the architecture search for a particular target system, for example a particular hardware accelerator. The comparability is available not only for optimizations, but also in general for the behavior of the target system.

In one aspect of the present invention, the first value for the function is determined by acquiring the property of the target system on the target system. Using the first set of values, characteristics of the relevant target system are acquired and taken into account in the model as data points.

In one aspect of the present invention, the first value for the function is determined by determining the property of the target system in a simulation of the target system. In this case, it is not necessary to survey the target system itself.

According to an example embodiment of the present invention, preferably, the property is a latency, in particular a duration of a computing time, a performance, in particular energy consumed per period of time, or a memory bandwidth. In the example, the duration of the computing time is that which occurs on the surveyed or simulated target system. In the example, the memory bandwidth, the performance, or the energy consumed per period of time relates to the surveyed or simulated target system. These are particularly suitable properties for the architecture search.

According to an example embodiment of the present invention, preferably, one of the parameters defines a size of a synapse, neuron, or filter in the artificial neural network and/or one of the parameters defines a number of filters in the artificial neural network and/or one of the parameters defines a number of layers of the artificial neural network that are combined in a task which can be executed by the target system in particular without part-results of the task being transferred into or from a memory that is external to the target system. These are particularly suitable hyperparameters for the architecture search, in particular in a deep neural network.

In one aspect of the present invention, a second set of values is determined for the parameters that define at least one part of a second architecture for the artificial neural network, a second value of the function being determined for the second set of values, said second value characterizing a property of the target system when the target system executes the task for the part of the artificial neural network that is defined by the second set of values for the parameters.

According to an example embodiment of the present invention, preferably, a first data point of the function is defined by the first set of values and the first value of the function, a second data point of the function being defined by the second set of values and the second value of the function, and a third data point of the function being determined by an interpolation between the first data point and the second data point. A plurality of data points may also be taken into account for the interpolation.

In one aspect of the present invention, for at least one data point out of a multiplicity of data points of the function, a measure of a similarity to the first data point is determined, the second data point, for which the similarity measure satisfies a condition, being determined out of the multiplicity of data points.

According to an example embodiment of the present invention, preferably, a function data point at which a gradient of the function satisfies a condition is determined, the data point defining a second set of values for the parameters for one part of a second architecture of the artificial neural network, the part of the architecture encompassing a plurality of layers of the artificial neural network and/or a plurality of operations of the artificial neural network, a second value of the function being determined for the second set of values for the parameters, said second value characterizing the property of the target system when the target system executes the task for the part of the artificial neural network that is defined by the second set of values for the parameters.

The gradient of the function may be determined for a multiplicity of data points of the function, a data point that has a greater gradient than the gradient of the function at other data points of the multiplicity of data points being determined out of the multiplicity of data points, and said data point defining the second set of values for the parameters.

For a multiplicity of data points, a value of the function at one data point of the multiplicity of data points may be determined, a data point for which the value satisfies a condition being determined, and said data point defining a result of the neural architecture search.

In one aspect of the present invention, a further value for a further parameter of the artificial neural network is determined independently of the function, and the architecture of the artificial neural network being determined on the basis of the further value.

According to an example embodiment of the present invention, a device for a neural architecture search is configured to carry out the method of the present invention.

Further advantageous embodiments of the present invention are set out in the following description and the figures.

### BRIEF DESCRIPTION OF THE DRAWINGS

FIG. 1 is a schematic illustration of a device for a neural architecture search, according to an example embodiment of the present invention.

FIG. 2 is a depiction of a function of a two-dimensional search space, according to an example embodiment of the present invention.

FIG. 3 shows steps in a method for determining the architecture, according to an example embodiment of the present invention.

### DETAILED DESCRIPTION OF EXAMPLE EMBODIMENTS

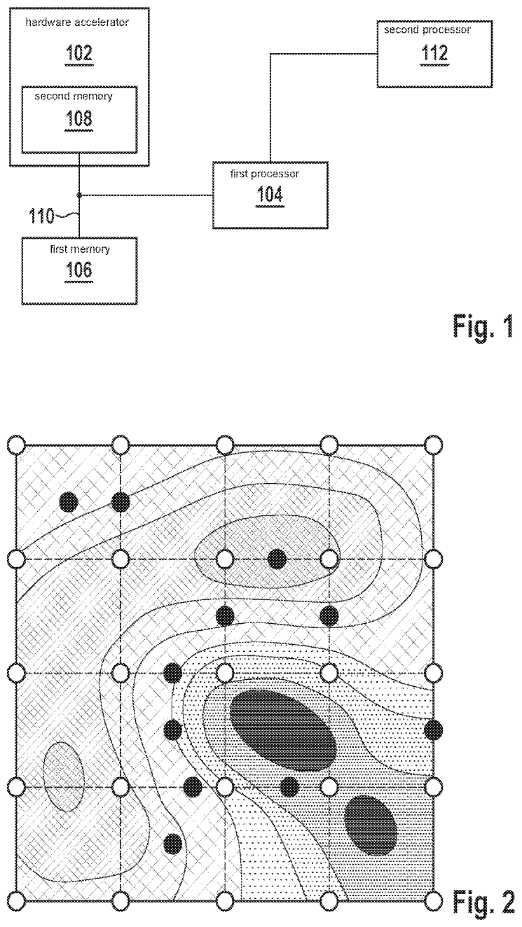

FIG. 1 schematically shows a device 100 for a neural architecture search. The device 100 comprises at least one processor and at least one memory, which are configured to interact in order to carry out the method described below. The neural architecture search is a method or an algorithm. The processor constitutes an arithmetic logic unit by which the neural architecture search can be executed. The processor may be part of a computing system, for example a personal computer. In the example, the neural architecture search is carried out for a target system, for example a hardware accelerator. In the rest of the description, the hardware accelerator is used as the target system. The approach can be applied likewise to other target systems.

The device 100 is configured to determine a property of a hardware accelerator 102. The hardware accelerator 102 is configured to carry out one or more tasks for a calculation for one part of an artificial neural network. By way of example, the hardware accelerator 102 is specialized hardware adapted for this task. In the example, the part of the artificial neural network encompasses a plurality of layers of the artificial neural network and/or a plurality of operations of the artificial neural network. This means that the hardware accelerator 102 is configured to carry out the required calculations. In the example, a first processor 104 is provided, which is configured to transmit data required for the calculation from a first memory 106 into a second memory 108. In the example, the first processor 104 is configured to transmit data representing results of the calculation from the second memory 108 into the first memory 106.

In the example, the first memory 106 is arranged outside the hardware accelerator 102. In the example, the second memory 108 is arranged inside the hardware accelerator 102.

In the example, the first memory 106 and the second memory 108 are connected via a first data line 110 at least for transmitting said data.

The device 100 may be configured to execute a measurement on the hardware accelerator 102 or to execute a simulation of the hardware accelerator 102. In the example, the measurement is controlled and/or executed by a second processor 112. If the hardware accelerator is simulated, the hardware accelerator 102, the first memory 106, and the first processor 104 are omitted. In this case, the hardware accelerator is simulated using the second processor 112.

In the example, the first processor 104 and the second processor 112 communicate at least intermittently for the measurement. In the measurement, the property of the hardware accelerator 102 is acquired. The property may be a latency, in particular a duration of a computing time by the hardware accelerator 102, a performance, in particular energy consumed by the hardware accelerator 102 per period of time, or a memory bandwidth for transmitting the data.

The simulation of the hardware accelerator 102 may determine the same properties on the basis of a model for the hardware accelerator 102.

A design of the artificial neural network is defined by an architecture of the artificial neural network. The architecture of the artificial neural network is defined by parameters. A parameter describes one part of the artificial neural network, for example one of its operations or layers or a part thereof. A subset of such parameters describes one part of the architecture of the artificial neural network. The architecture of the artificial neural network may also be defined by other parameters. These may additionally define the architecture.

For example, one parameter defines a size of a filter in the artificial neural network.

For example, one parameter defines a number of filters in the artificial neural network.

For example, one parameter defines a number of layers of the artificial neural network that are combined in a task. In the example, the task can be executed by the hardware accelerator 102 without any need to transfer part-results of the task from the second memory 108 into the first memory 106 and/or from the first memory 106 into the second memory 108.

The method described below involves solving an optimization problem; a solution to the optimization problem defines the architecture of a deep artificial neural network or a part thereof.

The solution comprises values for parameters out of a set of parameters that define the architecture of the artificial neural network. The architecture may also be defined by other parameters that are independent of the solution to the optimization problem.

The optimization problem is defined on the basis of a cost function. An example is described below in which the cost function is defined by a subset of parameters out of the set of parameters that define the artificial neural network. In the example, values of the cost function define the hardware costs, for example a latency or an energy consumption of the hardware accelerator 102 during execution of the task defined by the subset of parameters.

The cost function may also be defined by a multiplicity of such subsets. A plurality of parts of the architecture thus together form the object of the architecture search.

The set of parameters may be established in a manual step on the basis of expert knowledge. The aim of using a parameter is to evaluate an aspect of the architecture that cannot be evaluated by individual operations and/or layers since the aspect only takes effect over a plurality of layers or operations. This aspect may be interpreted as dimensions in a search space. The aspects relevant for the architecture search may be established using expert knowledge.

The subset of parameters may be determined in a manual step on the basis of expert knowledge. In the example, this subset comprises typical properties of algorithms by which the artificial neural network can be implemented, and the execution thereof on the hardware accelerator 102.

For a convolutional layer, for example, a parameter indicating a size k of a filter of the convolutional layer, e.g., kϵ{1,3,5,7}, is established. For the convolutional layer, a parameter indicating a number nb of filters of the convolutional layer, e.g., nb ϵ{4,8,16,32,64,128,256}, may be established in addition or instead.

For a fully connected layer, a parameter establishing a number of neurons, e.g., nϵ{4,8,16,32}, of the fully connected layer may be established.

For a skip connection, a parameter defining a length 1 that indicates a number of skipped layers of the artificial neural network may be established. For example, the length lϵ{1,3,5,7,9} is provided for an artificial neural network having rectified linear units (ReLU).

In the example, a skeleton that covers the parameters is created from said parameters. This may be a manual step executed on the basis of expert knowledge. An example skeleton s is shown below:
s (config, k, nb, n, l):
   for depth \in {1 to l}:
   if config.conv: add cony layer (k,nb)
   if config.fc: add fc layer (o)
   if config.activation: add ReLU layer( )
   if config.skip: add skip connection (layer 0, layer n-1)

The skeleton s defines a volume and a form of all possible sets of values for parameters in the search space, and in particular also the length thereof.

A subset of parameters may be selected from said subset of parameters, and parameters that are not selected are either not taken into account in the cost function or are not varied when solving the optimization problem.

The subset of the selected parameters, i.e., a number n of variable parameters, defines an n-dimensional search space of the optimization problem; each of the variable parameters is one of the dimensions.

Said selected parameters are selected on the basis of expert knowledge, for example. This step is optional.

In one aspect, the skeleton is created such that the individual dimensions of the search space can be evaluated optionally or separately. In one example, a dimension that is optional or can be evaluated separately can be deactivated for the neural architecture search. In one example, a dimension that is optional or can be evaluated separately can be set at a standard value for the neural architecture search, e.g., by a suitable config expression.

In many cases, this alone allows for a considerable reduction in the search space since individual dimensions of the search space are established using expert knowledge. If it is known, for example, that the hardware accelerator 102 for an accelerated calculation of a convolutional neural network (CNN) is based on a native hardware structure of a plurality of 3×3 filters, the size k of the filter need not be taken into account in the architecture search and can be set at 3 beforehand.

A reduction can be provided by ascertaining invariant dimensions.

The selection may be automated by varying individual parameters and evaluating a resulting change to the cost function. In this case, parameters for which the cost function is invariant are set at the standard value in the example to solve the optimization problem.

This selection is likewise conducive to reducing the search space and is based on the understanding that not every dimension is relevant for each hardware accelerator 102. By varying an individual dimension of the n-dimensional search space in a targeted manner without any further expert knowledge, an influence of that dimension can be checked. If the influence, e.g., the change to the cost function, is minor, this dimension is disregarded in the neural architecture search. This can be done entirely automatically.

Data points of the cost function may be dynamically ascertained. In the example, the data points of the cost function are ascertained in a controlled manner.

In one aspect, a further data point for the cost function is determined by an interpolation between the data points.

For example, further data points of the cost function are generated for the search space dimensions still remaining after the previous selection.

In one example, a plurality of such data points are predetermined in the n-dimensional search space spanned for that purpose. In the example, dynamic generation of further data points is used.

This will be explained on the basis of FIG. 2.

FIG. 2 schematically shows a cost function of a two-dimensional search space. In FIG. 2, empty circles represent predetermined data points of the cost function. In FIG. 2, solid circles represent further data points. The position of the further data points in the search space is determined on the basis of a measure of the uncertainty. In the example, the uncertainty measure is defined by a gradient between predetermined data points. In the example, a high gradient denotes high uncertainty. In the example, a low gradient denotes low uncertainty.

As a result of interpolation, with each further data point a further cost function that is increasingly precise is produced in the example shown in FIG. 2.

In the example, the further data points are derived from adjacent data points. Further data points may be added in addition or instead in such a way that further data points are primarily added in regions of high uncertainty, i.e., in regions having a high gradient.

This step can also be carried out fully automatically, for example by hardware-in-the-loop or simulator-in-the-loop.

To solve the optimization problem using n parameters, one point in the search space may be determined by predetermining different values for the number of parameters that are varied. One point in the search space is defined by n values for the n parameters. A value that the cost function has at this point is a measure on the basis of which an architecture can be selected using the solution to the optimization problem.

For a deep artificial neural network for a specific task, a search space thus defined is significantly larger than the number of operations of an individual deep artificial neural network for that task but is much smaller than the number of all possible deep artificial neural networks for that task.

In one aspect, the architecture search is executed on the basis of the generated cost function. By way of example, the architecture that minimizes the cost function is determined on the basis of the cost function.

Additional variable parameters and additional points in the search space may be determined for different parts of the architecture. This increases the dimension of the search space. The additional points of the search space can be taken into account in the interpolation for the cost function.

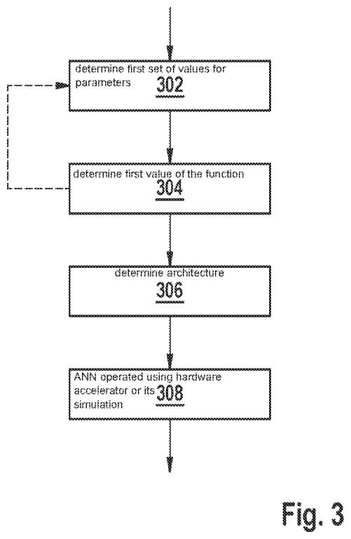

A computer-implemented method for determining the architecture is described below on the basis of FIG. 3.

In a step 302, a first set of values is determined for the parameters. The parameters define at least one part of the architecture for the artificial neural network.

In the example, one of the parameters defines a size of a synapse or neuron.

In the example, one of the parameters defines a size of a filter in the artificial neural network.

In the example, one of the parameters defines a number of filters in the artificial neural network.

In the example, one of the parameters defines a number of layers of the artificial neural network that are combined in the task. This means that, in the example, said layers are intended to be executable by the hardware accelerator 102 without part-results of the task being transferred into or from a memory that is external to the hardware accelerator.

In a step 304, a first value of the function is determined, said first value being associated with the first set of values for the parameters by the cost function.

The first value characterizes a property of the architecture.

In the example, the first value for the function is determined by acquiring the property of the hardware accelerator 102 on the hardware accelerator 102.

Alternatively, the first value for the function may be determined by determining the property of the hardware accelerator 102 in the simulation.

The property may be the latency, in particular the duration of the computing time, the performance, in particular the energy consumed per period of time, or the memory bandwidth.

In the example, the latency is defined as the time difference between the time at which the hardware accelerator 102 starts on the task and the time at which the hardware accelerator 102 completes the task. The task involves the calculation and transferring data, both before and after the calculation, to the next highest memory hierarchy (in the example: between the first memory 106 and the second memory 108).

In one aspect, a first data point of the cost function is defined by the first set of values and the first value of the cost function.

In the example, the first set of values is predetermined for parameters that define, for example, one to four layers of the artificial neural network. The cost function assigns to said set of values a value that indicates the hardware costs, for example the latency. In the example, the cost function itself is stored as a table in which the already known data points are stored. In the example, this table contains the measured hardware costs.

Steps 302 and 304 may be repeated. By way of example, in a repetition of step 302, a second set of values is determined for parameters that define at least one part of a second architecture for the artificial neural network. In this example, in a repetition of step 304, in particular carried out subsequently, a second value of the function is determined, said second value being associated with the second set of values by the function.

In a step 306, the architecture is determined.

By way of example, an architecture search, in particular a neural architecture search (NAS), is carried out.

The architecture search constitutes a complex optimization problem. Among other things, the complex optimization problem takes account of parameters of the artificial neural network that relate to the accuracy thereof. Among other things, the complex optimization problem takes account of parameters of the artificial neural network that take into account hardware costs which are to be expected owing to the architecture. Examples of parameters that influence the accuracy and hardware costs are, for example, the aforementioned parameters, in particular the number of neurons, the number of synapses, or filter size.

The architecture is defined on the basis of the parameters defined by the solution to the complex optimization problem. In this example, the parameters determined by this data point define at least one part of the architecture.

A further value for a further parameter of the artificial neural network may be provided or determined independently of the cost function. In this aspect, the architecture may be selected or configured on the basis of the further value.

In a step 308, the artificial neural network is operated using the hardware accelerator 102 or its simulation. By way of example, the artificial neural network comprising the hardware accelerator 102 is trained for computer vision and/or to evaluate radar signals and is used for that purpose once trained.

Steps 302 and 304 may be repeatedly executed to explore the search space in iterations. Preferably, the architecture is determined after a last iteration in step 306. In earlier iterations, new data points for the cost function can be created on the basis of existing data points of the cost function. A new data point of the cost function is determined, for example, in an area where the cost function has high inaccuracy. The new data points are additionally stored in the table, for example.

By way of example, a new data point is determined by an interpolation between a first data point and a second data point.

For the interpolation, a number, e.g., 2, 3, or 4, of similar data points may be determined and used for the interpolation. As part of the interpolation, an average of the values of the function of the interpolated data points may be used. The sets of values of the parameters can be used in order to ascribe a value for one of the parameters to the new data point by generating an average of the values of the same parameters at different data points.

For at least one data point out of a multiplicity of data points of the cost function, a measure of a similarity to the first data point may be determined. In this aspect, the second data point, for which the similarity measure satisfies a condition, is determined out of the multiplicity of data points.

By way of example, the similarity of data points may be defined in terms of the respective sets of values for the parameters.

Values for parameters established by an expert may also be used. The parameter may be a kernel size of a convolutional layer, for example.

By way of example, a difference between each value is determined for one of the parameters. For a plurality of parameters, respective differences can be added together. Individual differences may be standardized and then added together.

Alternatively, a gradient of the cost function may also be determined for a multiplicity of data points of the cost function. In this case, a cost function data point at which the gradient of the cost function satisfies a condition is determined. In this aspect, this data point defines the second data point or a new data point.

By way of example, a data point that has a greater gradient than the gradient of the cost function at other data points of the multiplicity of data points is determined out of the multiplicity of data points.

Alternatively, a value of the cost function may also be determined for a multiplicity of data points. In this aspect, a data point with a value that satisfies a condition is determined.

In this aspect, this data point defines the second data point or a new data point.

1-14. (canceled)

15. A computer-implemented method for a neural architecture search, the method comprising the following steps:
providing a first set of values for parameters that define at least one part of an architecture for an artificial neural network, the part of the architecture encompassing a plurality of layers of the artificial neural network and/or a plurality of operations of the artificial neural network;
determining a first value of a function for the first set of values for the parameters, the first value characterizing a property of a target system when the target system executes a task for the part of the artificial neural network that is defined by the first set of values for the parameters;
determining a second set of values for the parameters that define at least one part of a second architecture for the artificial neural network; and
determining a second value of the function for the second set of values, the second value characterizing a property of the target system when the target system executes the task for the part of the artificial neural network that is defined by the second set of values for the parameters;
wherein a first data point of the function is defined by the first set of values and the first value of the function, a second data point of the function is defined by the second set of values and the second value of the function, and a third data point of the function is determined by an interpolation between the first data point and the second data point.

16. The method as recited in claim 15, wherein the first value for the function is determined by acquiring the property of the target system on the target system.

17. The method as recited in claim 15, wherein the first value for the function is determined by determining the property of the target system in a simulation of the target system.

18. The method as recited in claim 16, wherein the property is a latency, the latency being a duration of a computing time or a performance or energy consumed per period of time or a memory bandwidth.

19. The method as recited in claim 15, wherein one of the parameters defines:
a size of a synapse or neuron or filter in the artificial neural network, and/or
a number of filters in the artificial neural network, and/or
a number of layers of the artificial neural network that are combined in a task which can be executed by the target system without part-results of the task being transferred into or from a memory that is external to the target system.

20. The method as recited in claim 15, wherein for at least one data point of a multiplicity of data points of the function, a measure of a similarity to the first data point is determined, the second data point, for which the similarity measure satisfies a condition, being determined from the multiplicity of data points.

21. The method as recited in claim 15, wherein a function data point at which a gradient of the function satisfies a condition is determined, the function data point defining the second set of values for the parameters for the at least one part of the second architecture of the artificial neural network and/or the part of the architecture encompassing a plurality of layers of the artificial neural network and/or a plurality of operations of the artificial neural network.

22. The method as recited in claim 21, wherein the gradient of the function is determined for a multiplicity of data points of the function, a data point that has a greater gradient than the gradient of the function at other data points of the multiplicity of data points being determined out of the multiplicity of data points, and the data point defining the second set of values for the parameters.

23. The method as recited in claim 15, wherein, for a multiplicity of data points, a value of the function at one data point of the multiplicity of data points is determined, a data point for which the value satisfies a condition being determined, and the data point defining a result of the neural architecture search.

24. The method as recited in claim 15, wherein a further value for a further parameter of the artificial neural network is determined independently of the function, and the architecture of the artificial neural network is determined based on the further value.

25. A device for a neural architecture search, the device configured to:
provide a first set of values for parameters that define at least one part of an architecture for an artificial neural network, the part of the architecture encompassing a plurality of layers of the artificial neural network and/or a plurality of operations of the artificial neural network;
determine a first value of a function for the first set of values for the parameters, the first value characterizing a property of a target system when the target system executes a task for the part of the artificial neural network that is defined by the first set of values for the parameters;
determine a second set of values for the parameters that define at least one part of a second architecture for the artificial neural network; and
determine a second value of the function for the second set of values, the second value characterizing a property of the target system when the target system executes the task for the part of the artificial neural network that is defined by the second set of values for the parameters;
wherein a first data point of the function is defined by the first set of values and the first value of the function, a second data point of the function is defined by the second set of values and the second value of the function, and a third data point of the function is determined by an interpolation between the first data point and the second data point.

26. A computer-readable medium on which is stored a computer program including computer-readable instructions for a neural network search, the instruction, when executed bya computer, causing the computer to perform the following steps:
providing a first set of values for parameters that define at least one part of an architecture for an artificial neural network, the part of the architecture encompassing a plurality of layers of the artificial neural network and/or a plurality of operations of the artificial neural network;
determining a first value of a function for the first set of values for the parameters, the first value characterizing a property of a target system when the target system executes a task for the part of the artificial neural network that is defined by the first set of values for the parameters;
determining a second set of values for the parameters that define at least one part of a second architecture for the artificial neural network; and
determining a second value of the function for the second set of values, the second value characterizing a property of the target system when the target system executes the task for the part of the artificial neural network that is defined by the second set of values for the parameters;
wherein a first data point of the function is defined by the first set of values and the first value of the function, a second data point of the function is defined by the second set of values and the second value of the function, and a third data point of the function is determined by an interpolation between the first data point and the second data point.
